(19) United States
(12) Patent Application Publication
(10) Pub. No.: US 2017/0248257 A1
(43) Pub. Date: Aug. 31, 2017

(54) Fitting with Removable Dip Tube

(71) Applicant: Gregory Daniel Webster, North East, MD (US)

(72) Inventor: Gregory Daniel Webster, North East, MD (US)

(21) Appl. No.: 15/055,461

(22) Filed: Feb. 26, 2016

(51) Int. Cl. F16L 15/00; F16L 21/03; F16L 15/04

(52) U.S. Cl. CPC F16L 15/008; F16L 15/04; F16L 21/03

(57) ABSTRACT

A weldless thru wall fitting that provides a leak free connection to a vessel that can easily be installed and removed. The fitting also provides an integrated, removable, and repositionable dip tube to allow the liquid stored in the vessel to the drained via gravity to a level below the entry point of the fitting.

### BACKGROUND OF THE INVENTION

The present invention relates to fittings and, more particularly, to a fitting having an integrated dip tube.

It is often desired to connect plumbing components, such as valves and related plumbing, to tanks or vessels as a means to move liquids into and out of the tank or vessel. The connection must be made in a manner that the liquid is only permitted to pass from the tank or vessel into the connected plumbing and not be allowed to escape or leak at the interface between the plumbing and the tank. The installation method should be as easy as possible and also allow the hardware to be removed for cleaning. When draining the tank or vessel, a person should remove liquid to a level below that of where the plumbing connection is made. Currently, devices or methods are prone to leaks at the interface between the bulkhead fitting and the tank or vessel wall. It is also difficult to install a simple, easy to clean dip tube on the inside of the tank or vessel utilizing the provided threads on similar devices.

As can be seen, there is a need for a fitting that is easy to install that allows a leak free connection to tank or vessel and provides an integrated dip tube.

### BRIEF DESCRIPTION OF THE DRAWINGS

FIG. 1 shows an example of how the invention could be installed on a tank or vessel.

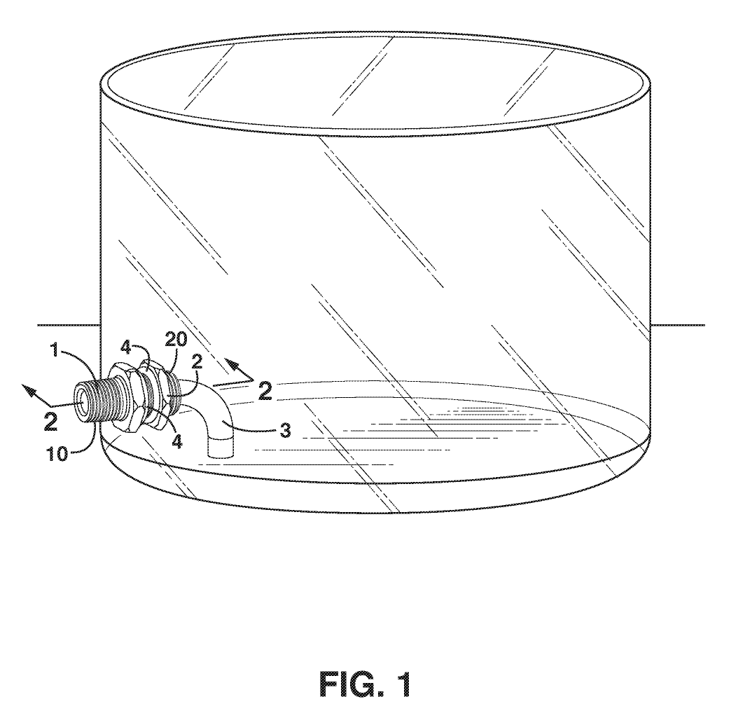

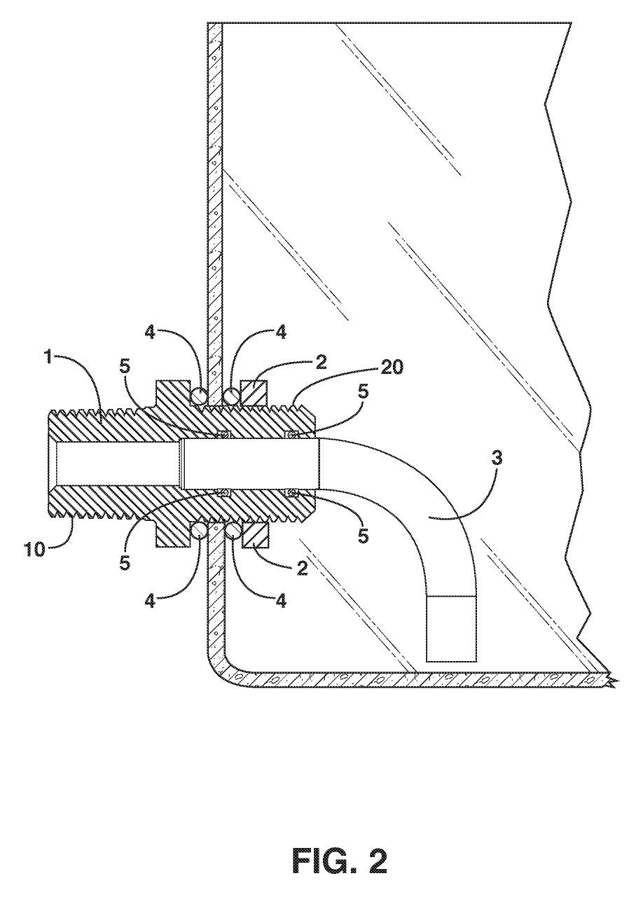

The FIG. 2 is a side detail view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a fitting comprising: a fitting body comprising tapered pipe threads on a first side, straight threads on a second side, and an interior housing; at least one jam nut along the second side of the fitting body; a dip tube within the interior housing of the fitting body; at least one o-ring positioned along the first side and the second side of the outside of the fitting body; and at least one o-ring along the interior housing of the fitting body. The fitting provides a leak-free, removable connection when installed through a hole of an appropriate size formed in the wall of a tank or vessel. The tapered threads on the first side of the fitting allow for the connection of a valve or other plumbing to the outside of the tank or vessel.

As is illustrated in the FIG. 2, a fitting may include a fitting body 1 having a tapered pipe threaded first side 10 and a straight threaded second side 20. The first side 10 of the fitting body 1 may be outside of a vessel, and the second side 20 of the fitting body 1 may be inside a vessel. The fitting body 1 may also have an interior housing. A dip tube 3 may be within the interior housing of the fitting body 1. The dip tube 3 may have a bend of approximately 90 degrees. At least one inside o-ring 5 may be inserted into the interior housing of the fitting body 1 along internal o-ring glands and around the outside of the dip tube 3. At least one outside o-ring 4 may be positioned along the outside of the fitting body 1 along the second side 20. A jam nut 2 may be threaded onto the fitting body 1 on the second side 20.

The inside o-rings 5 may be inserted into the internal grooves in the fitting body. One outside o-ring 4 may be fitted over the straight threads of the fitting body 1 until it contacts the side of a hexagonal feature on the fitting body. The assembly may then be inserted from the outside of the tank or vessel through a hole of the same diameter as the straight threads in the tank or vessel straight threaded end first. From the inside of the tank or vessel the second outside o-ring 4 may be installed on the straight threads until the outside o-ring 4 contacts the inside of the tank or vessel wall. The jam nut 2 may be then threaded on to straight threads of the fitting body 1 from the inside of the tank or vessel compressing the o-rings located inside and outside of the tank or vessel. The jam nut 2 may be tightened until sufficient pressure may be applied to the o-rings so that no liquid leaks at the interface between the tank or vessel and the fitting body1. The hexagonal features on the fitting body 1 and the jam nut 2 may allow wrenches to be used to tighten the device if needed. Finally, the dip tube 3 may be inserted from the inside of the tank or vessel into the provided hole in the fitting body 1. The inside o-rings 5 in the fitting body 1 may provide a leak free seal between the dip tube 3 and fitting body 1 but still allow the dip tube 3 to move rotated to any angle and removed and replaced for easy cleaning without removing the fitting body from the tank or vessel.

To use this fitting, one may install the fitting on a tank or vessel that they wish to make a leak free plumbing connection to as described previously. The tank or vessel may then be filled with a liquid above the level of the bulkhead fitting. The liquid may then be permitted to drain or be drawn from the tank or vessel down to the level of the opening of the dip tube without leaking at the bulkhead fitting interface. The entire assembly may easily be removed for cleaning when desired.

It should be understood, of course, that the foregoing relates to exemplary embodiments of the invention and that modifications may be made without departing from the spirit and scope of the invention as set forth in the following claims.

What is claimed is:

1. A fitting comprising:
a fitting body with tapered pipe threads on a first side, straight threads on a second side, and an interior housing;
at least one jam nut along the second side of the fitting body;
a dip tube within the interior housing of the fitting body;
at least one o-ring positioned along the first side and the second side of the outside of the fitting body; and
at least one o-ring along the interior housing of the fitting body
